(19) United States
(12) Patent Application Publication
(10) Pub. No.: US 2015/0352950 A1
(43) Pub. Date: Dec. 10, 2015

(54) INTEGRATED NOISE SUPPRESSION MECHANISM AND METHOD OF USING THE SAME

(71) Applicant: THERMO KING CORPORATION, Minneapolis, MN (US)

(72) Inventors: Jon Alan DeTuncq, Richfield, MN (US); Steven Michael Gleason, Golden Valley, MN (US)

(21) Appl. No.: 14/300,723

(22) Filed: Jun. 10, 2014

(51) Int. Cl. B60K 25/00; F01N 13/18; F01N 1/00

(52) U.S. Cl. CPC B60K 25/00; F01N 1/00; F01N 13/18

(57) ABSTRACT

An enclosure unit for enclosing a portion of a noise source includes an access panel that allows access to the noise source from an outside of the enclosure unit; and a noise suppression mechanism attached to the access panel. The noise suppression mechanism includes a circumferential conformal barrier configured to bracket the portion of the noise source. The conformal barrier including a base end configured to be attached to an inner surface of the access panel, a free end positioned opposed to the base end and a wall extending between the base end and the free end.

### FIELD

This disclosure relates generally to a noise control system, and particularly, but not by way of limitation, to apparatuses and methods for suppressing noises generated by a noise source.

### BACKGROUND

Operation of internal combustion engine systems inherently produces audible sound. In many environments, engine noise is considered objectionable, particularly at certain frequencies and intensities. The multitude of moving parts and combustion explosions associated with engine operation tend to generate noise in a frequency range and at intensities which can be unpleasant to operators and bystanders in the general vicinity of an engine.

### SUMMARY

This disclosure relates generally to a noise control system, and particularly, but not by way of limitation, to apparatuses and methods for suppressing noises generated by a noise source.

Some embodiments of a noise suppression mechanism can be attached to a panel, such as an access panel, of a noise source unit that encloses a noise source such as an engine. In such circumstances, the noise suppression mechanism can include a conformal barrier configured to have structural integrity such that it is capable of maintaining its shape even when the conformal barrier is not supported by the noise source. For example, the conformal barrier can take the form of a circumferential flange extending from the inner surface of an access panel toward the noise source such that the circumferential flange forms a conforming fit with the outer surface of the noise source.

In some embodiments, the noise suppression mechanism can also include an interface member coupled to the conformal barrier at a location in a vicinity of the free end. The interface member is configured to help prevent vibration of the noise source from transferring to the panel of the noise source unit. This effectively helps prevent the noise source from re-radiating noise from the panel.

In some alternative embodiments, the noise suppression mechanism can include a conformal barrier that is in a more flexible form such as a flexible curtain or a soft, conformal pillow attached to a panel of the noise source unit. In some embodiments, the noise suppression mechanism can be positioned at a removed position such that it is moved away from the noise source to permit access to the noise source as the access panel is opened to allow easy access to the noise source. The noise suppression mechanism can also be positioned at a deployed position when the access panel is returned to a closed position to provide a noise barrier.

Moreover, the noise suppression mechanism can be configured to address a specific area of the noise source such that only a portion of an entire outer surface area of the noise source is covered by the noise suppression mechanism. This can effectively limit the amount of heat that is confined by the noise suppression mechanism, and thus can allow free convection over most of surfaces of the noise source. Thus, the noise suppression mechanism can help provide a cost-efficient method for noise control.

Further, in some embodiments, the noise suppression mechanism can be configured to provide a load path between a top panel of an engine unit of a noise source and the noise source, thereby facilitating transfer of a load applied on the top panel to underlying structures of the noise source. For example, in embodiments where the noise source is an auxiliary power unit (APU), the top panel of an engine unit of the APU can flex under load, causing a portion of the noise suppression mechanism to come into contact with the engine unit below it, thereby facilitating transfer of the load to underlying engine structures.

In some embodiments, an enclosure unit for enclosing a portion of a noise source includes an access panel that allows access to the noise source from an outside of the enclosure unit, and a noise suppression mechanism attached to the access panel. The noise suppression mechanism includes a circumferential conformal barrier configured to bracket the portion of the noise source. The conformal barrier includes a base end configured to be attached to an inner surface of the access panel, a free end positioned opposed to the base end and a wall extending between the base end and the free end.

Other embodiments include a noise suppression mechanism for suppressing noise generated by a noise source. The noise suppression mechanism includes a circumferential conformal barrier. The conformal barrier has a base end, a free end opposite the base end and a wall extending between the base end and the free end. The noise suppression mechanism also has an interface member coupled to an inner surface of the wall of the conformal barrier at a location in a vicinity of the free end. The interface member is made of a compliant material. The noise suppression mechanism further has a noise treatment member positioned in a vicinity of the base end of the conformal barrier. An outer circumferential edge of the noise treatment member is in contact with an inner surface of the conformal barrier.

Other embodiments include a method of attaching a noise suppression mechanism to an enclosure unit that encloses a noise source. The method includes attaching a conformal barrier to an inner surface of a panel of the enclosure unit such that the conformal barrier has a conforming fit with an outer surface of the noise source. These and other embodiments described herein may provide one or more of the following benefits. In some embodiments, the noise suppression mechanism can be attached to an access panel of an engine unit of a noise source. In these embodiments, the noise suppression mechanism can include a conformal barrier configured to have structural integrity such that it is capable to maintain its shape even when the conformal barrier is not supported by the noise source.

Also, the noise suppression mechanism can be configured to address a specific area of the noise source such that only a portion of an entire outer surface area of the noise source is covered by the noise suppression mechanism, thereby limiting effectively the amount of heat that is confined by the noise suppression mechanism, and thus allowing free convection over most of surfaces of a noise source.

Further, the noise suppression mechanism can be configured to provide a load path between a top panel of an engine unit of a noise source and the noise source itself, thereby facilitating transfer of a load applied on the top panel to underlying structures of the noise source.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 illustrates a first embodiment of a noise suppression mechanism for suppressing noise generated by a noise source.

FIG. 2 illustrates the first embodiment of the noise suppression mechanism of FIG. 1 when used as a load path.

FIG. 3 illustrates a second embodiment of the noise suppression mechanism.

FIG. 4 illustrates a third embodiment of the noise suppression mechanism.

FIG. 5 illustrates a fourth embodiment of the noise suppression mechanism.

Like reference symbols in the various drawings indicate like elements.

### DETAILED DESCRIPTION

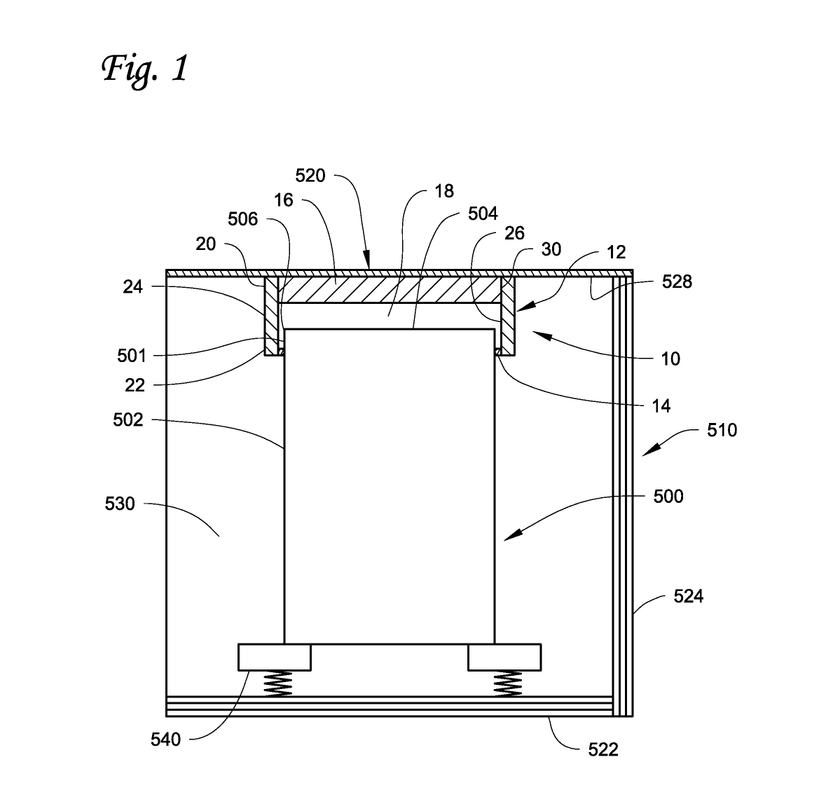

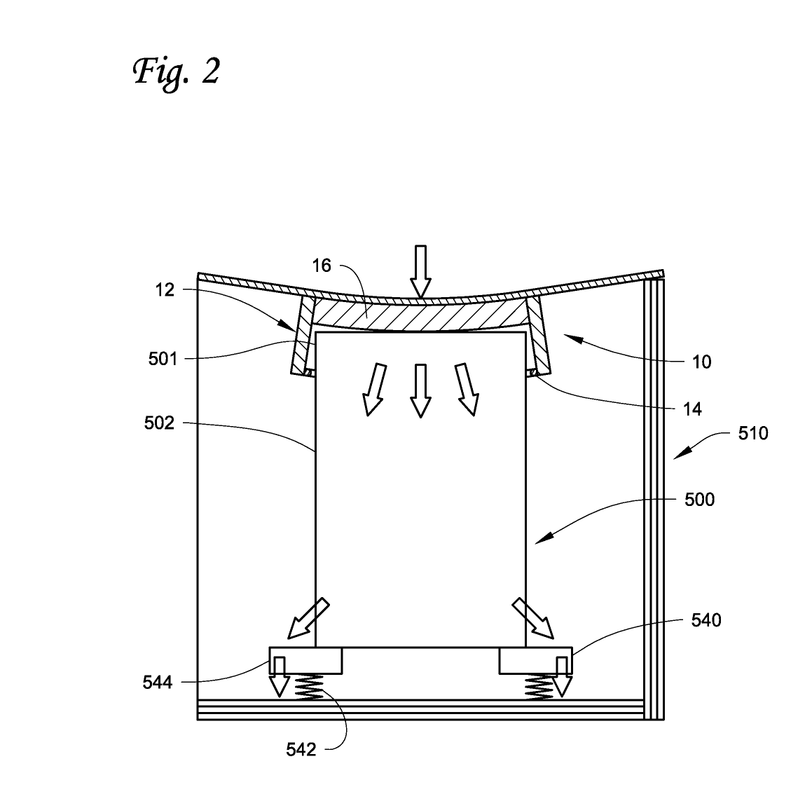

Referring to FIGS. 1 and 2, a noise suppression mechanism 10 can be used to suppress noise generated by a noise source. It is to be understood that the noise suppression mechanism 10 can be used to suppress noise generated by various types of noise sources. The term “noise source” refers to a device that generates undesired sound, such as, an internal combustion engine, a compressor, an engine intake manifold, an exhaust manifold, a muffler shell, a gear drive, an injector pump, a fuel pump, an oil sump, any motor driven device, etc. Solely for the sake of convenience, the noise source will be described in the embodiments below as an internal combustion engine 500. As shown in FIGS. 1 and 2, the engine 500 is positioned in an engine unit 510. The engine unit 510 includes a top panel 520, a bottom panel 522 and a side panel 524 extending from the top panel 520 to the bottom panel 522. The panels 520, 522, 524 of the engine unit 510 define an internal space 530.

The noise suppression mechanism 10 is attached to the top panel 520 which is also an access panel that can be opened and closed to allow a user to access the engine 500. When in use, the noise suppression mechanism 10 can be positioned at a deployed position when the top panel 520 is closed in a position as shown in FIG. 1. The noise suppression mechanism 10 can also be positioned at a removed position such that is moved away from the noise source to permit access to the noise source as the top panel 520 is opened, allowing easy access to the engine 500.

In some embodiments, the noise suppression mechanism 10 includes a conformal barrier 12 that surrounds a portion 501 of the engine 500, such as an engine cylinder head. However, it is to be understood that the noise suppression mechanism 10 can be configured to surround other portions of the engine, as desired.

In the depicted embodiment as shown in FIGS. 1 and 2, the conformal barrier 12 is configured to have structural integrity such that it is capable to hold its shape even when the conformal barrier 12 is removed from the engine 500. As shown in FIGS. 1 and 2, the conformal barrier 12 is a circumferential flange extending from an inner surface 528 of the top panel 520 towards the inner space 530, enclosing the corresponding portion 501 of the engine 500, and has a conforming fit with the outer surface 502 of the engine 500. For example, in the depicted embodiment, the conformal barrier 12 is shaped to conform along a contacting edge 506 of the engine 500. The conformal barrier 12 can be made by various processes, including but not by way of limitation, molding such as blow molding, injection molding, etc. The conformal barrier 12 can also be formed using die-cut parts. Materials used to make the conformal barrier can include a flexible rubber curtain.

As shown in FIGS. 1 and 2, the circumferential conformal barrier 12 includes a base end 20 attached to the inner surface 528 of the top panel 520, a free end 22 and a wall 24 extending between the base end 20 and the free end 22. It is to be understood that the conformal barrier 12 can be configured in other forms, such as a flexible curtain or a soft, conformal pillow attached to the top panel 520 of the engine unit 510.

The conformal barrier 12 can be attached to the inner surface 528 of the top panel 520 by a suitable fastening mechanism, such as adhesive, rivets, snap-fit connections, nut-bolt assemblies, or the like.

It is to be understood that the conformal barrier 12 can be made of various sound absorbing materials (e.g., sound barriers). In some embodiments, the conformal barrier 12 can takes the form of a mass-loaded barrier member which is made of a sound absorbing material such as, for example, a foam polyurethane containing a thermosetting resin. Examples of sound absorbing materials can include, but are not limited to, a woven or non-woven fibrous pad, a polyurethane foam or a similar open-cell foam that has a Mylar face or an open-face, a flat material, a shaped material (e.g., a saw-toothed material), Melamine foam (e.g., for use in higher temperature applications), fiberglass, Thinsulate™ from 3M Company of St. Paul, Minn., USA, a sandwiched foam (e.g., a foam/rubber/foam combination), a quilted absorber, an encapsulated cotton shoddy or other loose fill acoustic materials, etc.

The conformal barrier 12 can also include a material coupled with the sound absorbing material that helps maintain the shape of the sound absorbing material. Examples of a sound absorbing material can include, for example, a dense, flexible rubber, a sheet metal, a molded plastic, a cast foam (e.g., polystyrene), a molded plastic, one or more extruded shapes pieced together, a co-extrusion material (e.g., a soft material extruded with a stiffer material in the same cross section), etc.

The conformal barrier 12 may be formed in any suitable manner such as, for example, an injection molding, a stamping, a weldment, a formed metal part, or the like. For example, in some embodiments, a sound absorbing material can be die cut from sheet stock or be formed from a simple extrusion, and then attached to the inner surface 528 of the top panel 520 of the engine unit 510.

Still referring to FIGS. 1 and 2, the noise suppression mechanism 10 can also include an interface member 14 coupled to the wall 24 at a location in a vicinity of the free end 22. In one embodiment, the term “in a vicinity of” can refer to a distance ranging up to about two inches. The interface member 14 is configured to help prevent vibration of the engine 500 from transferring to the top panel 520 of the engine unit 510. This can help prevent the engine 500 from re-radiating noise from the top panel 520. It is appreciated that in other embodiments, the interface member 14 can be coupled to other portions of the conformal barrier 12, rather than the free end 22, as long as the interface member 14 is located on the inner surface 26 of the wall 24.

The interface member 14 can have various configurations. In the embodiment shown in FIGS. 1 and 2, the interface member 14 is placed on an inner surface of the wall 24 along the free end 22 such as the interface member 14 and surrounds the perimeter of the engine 500. In other embodiments, the interface member 14 can take a form of one or more extruded bulb seals, or the like. The interface member 14 can be constructed by an elastic material, such as foam or soft rubber. It is to be understood that the interface member 14 can be made of various materials. In one embodiment, the interface member 14 can be made of a compliant material that is, for example, softer, more flexible, more conformal and/or more pliable than the conformal barrier 12. As used throughout this disclosure, the term “compliant” is intended to refer to materials that are relatively soft and/or flexible which allows the material to deform and deflect in response to the application of a sudden load, such as a sudden load caused by a road shock.

In addition, the noise suppression mechanism 10 can include a noise treatment member 16 disposed in an air cavity 18 formed between the engine 500 and the inner surface 528 of the top panel 520 of the engine unit 510. The air cavity 18 can help avoid wear and fretting from frequent small motions of the noise source against the acoustic materials. The air cavity 18 can also help avoid heat aging from direct contact with a hot surface. In some embodiments, the noise treatment member 16 can be sized to contact a top surface of the engine 500 if the material of the noise treatment member 16 is able to withstand the contact or there may be no significant relative motion between the noise treatment member 16 and the engine 500. In the depicted embodiment as shown in FIGS. 1 and 2, the noise treatment member 16 is configured to have a flat body extending throughout an area of the inner surface 528 that is enclosed by the conformal barrier 12. An outer circumferential side 30 of the noise treatment member 16 is in contact with an inner surface 26 of the wall 24 of the conformal barrier 12.

The flat body of the noise treatment member 16 can be attached to the inner surface 528 via a suitable adhesive or fastener including, but not limited to, one or more rivets, screws, one or more Christmas tree fasteners, one or more posts with push-on retainers, one or more threaded inserts and bolts, one or more locking tabs, a pressure sensitive adhesive, an epoxy and glue, a welding (e.g., stitch or spot weld) process, a netting or screen, one or more wire grill staples, tape, etc.

The noise treatment member 16 can be made of any sound absorbing material including, but not limited to, a polyurethane foam or similar open-cell foam (which can be, for example, Mylar facing or open faced and can be a flat material or shaped (e.g., saw-toothed), a Melamine foam (which can be used for higher temperature applications), fiberglass, Thinsulate™ from 3M Company of St. Paul, Minn., USA, a sandwiched foam (e.g., a foam/rubber/foam sandwiched foam), a quilted absorber, an encapsulated cotton shoddy or other loose fill acoustic materials, etc.

It is to be understood that the sound absorbing materials used to make the conformal barrier 12, the interface member 14 or the noise treatment member 16 can be a material capable of withstanding high temperatures of about 200° F. or greater. In such circumstances, the noise suppression mechanism 10 can be used to treat noise from noise sources that may have high temperatures, such as compressors, exhaust manifolds, muffler shells, or the like. The simple structure of the noise suppression mechanism 10 can help to effectively reduce the cost and time for making noise-reduced compressors, exhaust manifolds, muffler shells, etc.

Still referring to FIGS. 1 and 2, in some embodiments, the noise suppression mechanism 10 is used to address noises emitted from a specific area of the engine 500, such as a top 504 of the engine 500, a side of an engine, etc. In some embodiments, the noise suppression mechanism 10 can be positioned to cover, for example, only the top portion of an entire outer surface area of the engine, such as ˜30% or less. This can limit effectively the amount of heat that is confined by the noise suppression mechanism 10, and thus allows free convection over most of the outside engine surface 502. In some embodiments, it can be even a smaller percentage if a particular surface area emits high intensity noise. In other embodiments, the coverage can be about ˜50% if the noise source is a more uniform emitter and there are appropriate accesses to cover the noise source. It is to be appreciated that the noise suppression mechanism 10 can also be used to suppress noise emitted by an injector pump, a fuel pump, an oil sump, a gear cover, a compressor piston head, an engine intake manifold, a motor housing, a compressor sump or body, a gear drive, etc.

Referring to FIG. 2, in some embodiments, the noise suppression mechanism 10 can be configured to provide a load path between the top panel 520 of the engine unit 510 and the engine 500, thereby facilitating transfer of a load applied on the top panel 520 to underlying structures 540 that are used to support the engine 500, such as springs 542, the mounting system 544, or the like (as shown by the arrows in FIG. 2). For example, in embodiments, the engine unit 510 is an auxiliary power unit (APU). In such instances, the use of the noise suppression mechanism 10, and in particular the use of the noise treatment member 16, allows the engine 500 to be used as a step or platform such that a user can stand on top of the top panel 520 of the engine unit 510. Specifically, when a load is applied on the top panel 520 of the engine unit 510, the top panel 520 can flex and cause the noise treatment member 16 to come into contact with the engine side surface 502 and the engine top surface 504 below the noise treatment member 16, thereby facilitating transfer of the load to underlying structures 540. The term “load path” as used herein refers to a force transfer path.

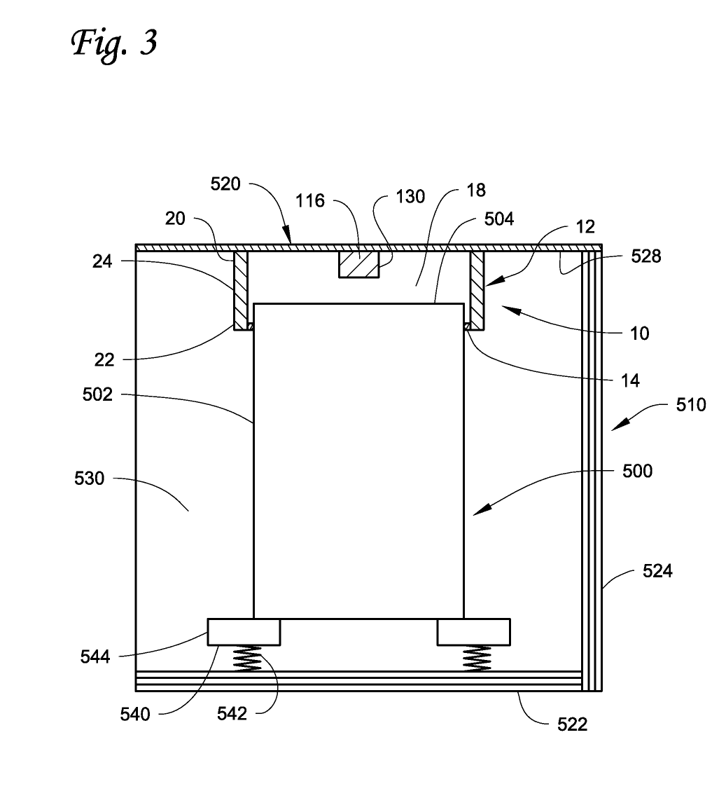

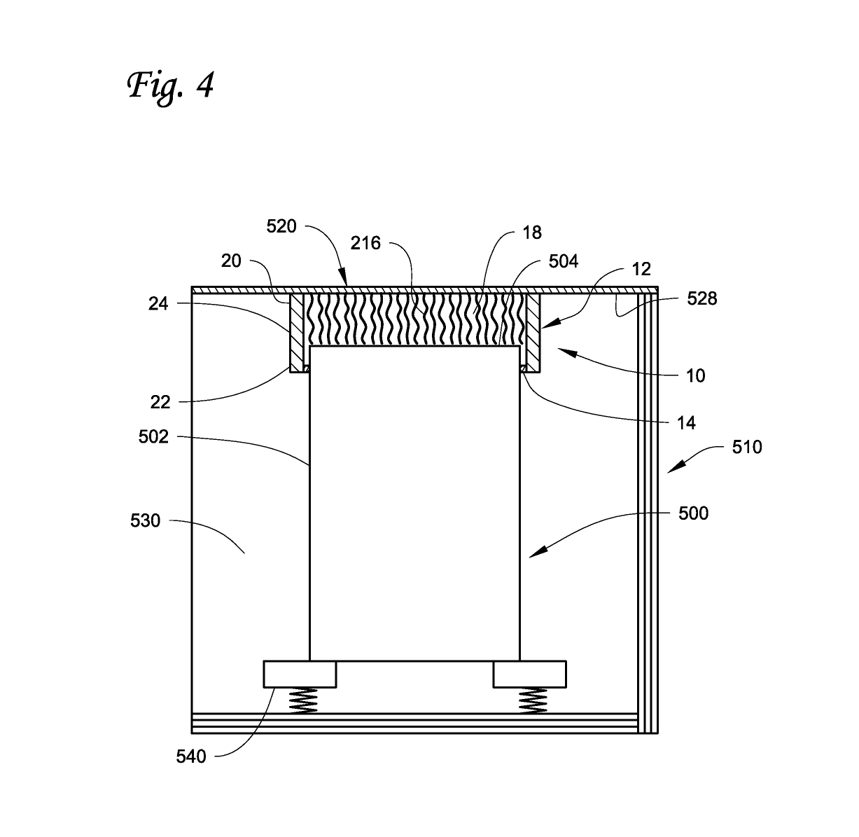

It is to be understood that the noise treatment member 16 of the noise suppression mechanism 10 can take a form of not only a flat configuration covering an entire portion of an inner surface 528 defined by the conformal barrier 12 above the engine unit 500 as shown in FIGS. 1 and 2, but also other configurations, such as a localized configuration covering a localized portion of the inner surface 528 of the top panel 520 as shown in FIG. 3, or a loose draping material attached to the inner surface 528 as shown in FIG. 4. The embodiments in FIGS. 3 and 4 will be described in more detail below.

Referring now to FIG. 3, in some embodiments, the noise suppression mechanism 10 includes a noise treatment member 116 disposed in the air cavity 18 formed between the engine 500 and the inner surface 528 of the top panel 520 of the engine unit 510. The noise treatment member 116 is configured to have a localized configuration, where an outer circumferential edge 130 of the noise treatment member 116 does not come in contact with the conformal barrier 12. For example, as shown in FIG. 3, the localized configuration can take a form of a strip secured to and extending along the inner surface 528 of the top panel 520. The strip can be located at the center of the area defined by the conformal barrier 12. Alternatively, the strip can be located at another location in the area defined by the conformal barrier 12 and best suited to absorb the noise from the engine 500.

Referring now to FIG. 4, in some embodiments, the noise suppression mechanism 10 includes a noise treatment member 216 disposed in an air cavity 18 formed between the engine 500 and the inner surface 528 of the top panel 520 of the engine unit 510. The noise treatment member 216 takes a form of a loose draping material attached on the inner surface 528. For example, as shown in FIG. 4, the loose draping material can cover the entire area of the inner surface 528 that is defined by the conformal barrier 12, Alternatively, the loose draping material can have a localized configuration, such as draping from the center or another location of the area defined by the conformal barrier 12 and best suited to absorb the noise from the engine 500.

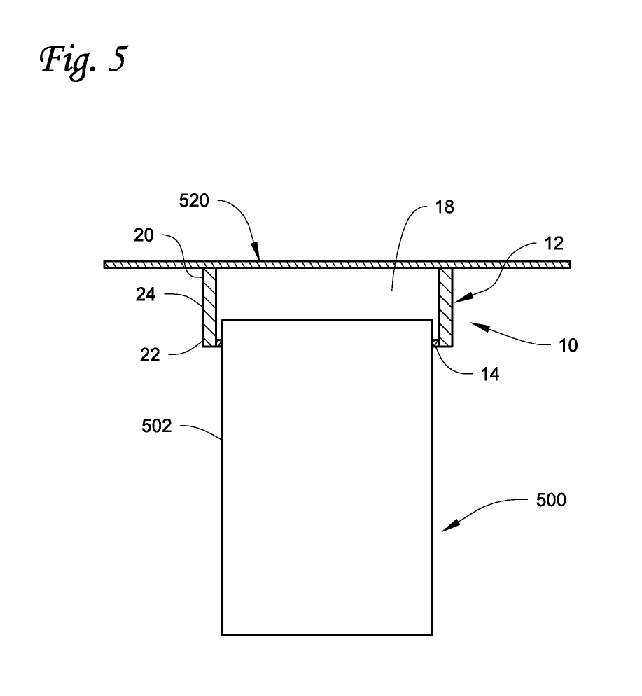

Referring now to FIG. 5, in some embodiments, the noise suppression mechanism 10 merely includes the conformal barrier 12 and the interference member 14, but does not include a noise treatment member.

In the embodiments as shown in FIGS. 1-5 where the top panel 520 is an access panel, when in use, the noise suppression mechanism 10 can be positioned at a deployed position when the top panel 520 is closed. The noise suppression mechanism 10 can also be positioned at a removed position such that the conformal barrier 12 and the noise treatment member 16, 116, 216 are moved away from the noise source to permit access to the noise source as the top panel 520 is opened, thereby allowing easy access to the engine 500. The configuration of the noise suppression mechanism 10 can help avoid situations where sound absorbing materials are forgotten to be put back in the engine unit 510 after the sound absorbing materials are moved away from the engine unit 510 for access to the engine 500.

### Aspects:

It is noted that any of aspects 1-2 below can be combined with any of aspects 3-11 and aspects 12-14. Also, any of aspects 3-11 below can be combined with any of aspects 12-14.

1. A noise suppression mechanism for suppressing noise generated by a noise source, the noise suppression mechanism comprising:

a circumferential conformal barrier including a base end, a free end opposite the base end and a wall extending between the base end and the free end;

an interface member coupled to an inner surface of the wall of the conformal barrier at a location in a vicinity of the free end, the interface member being made of a compliant material; and

a noise treatment member positioned in a vicinity of the base end of the conformal barrier, wherein an outer circumferential edge of the noise treatment member is in contact with an inner surface of the conformal barrier.

2. The noise suppression mechanism of aspect 1, wherein the circumferential conformal barrier includes a first sound absorbing material and a second material coupled with the first sound absorbing material, the second material being configured to maintain the shape of the first sound absorbing material.
3. An enclosure unit for enclosing a noise source, comprising:

an access panel configured to allow access to the noise source from an outside of the enclosure unit; and

a noise suppression mechanism attached to the access panel, the noise suppression mechanism comprising:

a circumferential conformal barrier configured to bracket the portion of the noise source, the conformal barrier including a base end configured to be attached to an inner surface of the access panel, a free end positioned opposed to the base end and a wall extending between the base end and the free end.

4. The enclosure unit of aspect 3, further comprising an interface member coupled to an inner surface of the wall of the conformal barrier at a location in a vicinity of the free end, the interface member is configured to be positioned between the conformal barrier and an outer circumferential side of the noise source.
5. The enclosure unit of any of aspects 3-4, wherein the interface member is made of a compliant material.
6. The enclosure unit of any of aspects 3-5, wherein the conformal barrier is configured to be positioned at a removed position when the noise suppression mechanism is moved away from the noise source to permit access to the noise source as the access panel is being opened, and a deployed position where the suppression mechanism is positioned to enclose the portion of the noise source when the access panel is returned to a closed position.
7. The enclosure unit of any of aspects 3-6, wherein the noise suppression mechanism is configured to cover ˜30% or less of an entire outer surface area of the noise source.
8. The enclosure unit of any of aspects 3-7, wherein the noise suppression mechanism further includes a noise treatment member positioned in a vicinity of the base end of the conformal barrier, an outer circumferential edge of the noise treatment member being in contact with the inner surface of the conformal barrier.
9. The enclosure unit of aspect 8, wherein the noise treatment member is configured to cover an entire area of the inner surface of the access panel defined by the conformal barrier.
10. The enclosure unit of aspect 8, wherein the noise treatment member is configured to cover only a portion of the inner surface of the access panel defined by the conformal barrier.
11. The enclosure unit of aspects 8-10, wherein the noise treatment member includes a material draping from an area of the inner surface of the access panel defined by the conformal barrier.
12. A method of attaching a noise suppression mechanism to an enclosure unit that encloses a noise source, comprising:

attaching a conformal barrier to an inner surface of a panel of the enclosure unit such that the conformal barrier has a conforming fit with an outer surface of the noise source.

13. The method of aspect 12, further comprising attaching an interface member to an inner surface of the wall of the conformal barrier.
14. The method of any of aspects 12-13, further comprising attaching noise treatment member at a vicinity of the base end of the conformal barrier.

A number of embodiments of the invention have been described. Nevertheless, it will be understood that various modifications may be made without departing from the spirit and scope of the invention. Accordingly, other embodiments are within the scope of the following claims.

1. A noise suppression mechanism for suppressing noise generated by a noise source, the noise suppression mechanism comprising:
a circumferential conformal barrier including a base end, a free end opposite the base end and a wall extending between the base end and the free end;
an interface member coupled to an inner surface of the wall of the conformal barrier at a location in a vicinity of the free end, the interface member being made of a compliant material; and
a noise treatment member positioned in a vicinity of the base end of the conformal barrier, wherein an outer circumferential edge of the noise treatment member is in contact with an inner surface of the conformal barrier.

2. The noise suppression mechanism of claim 1, wherein the circumferential conformal barrier includes a first sound absorbing material and a second material coupled with the first sound absorbing material, the second material being configured to maintain the shape of the first sound absorbing material.

3. An enclosure unit for enclosing a noise source, comprising:
an access panel that allows access to the noise source from an outside of the enclosure unit; and
a noise suppression mechanism attached to the access panel, the noise suppression mechanism comprising:
a circumferential conformal barrier configured to bracket the portion of the noise source, the conformal barrier including a base end configured to be attached to an inner surface of the access panel, a free end positioned opposed to the base end and a wall extending between the base end and the free end.

4. The enclosure unit of claim 3, further comprising an interface member coupled to an inner surface of the wall of the conformal barrier at a location in a vicinity of the free end, the interface member is configured to be positioned between the conformal barrier and an outer circumferential side of the noise source.

5. The enclosure unit of claim 4, wherein the interface member is made of a compliant material.

6. The enclosure unit of claim 4, wherein the conformal barrier is configured to be positioned at a removed position when the noise suppression mechanism is moved away from the noise source to permit access to the noise source as the access panel is being opened, and a deployed position where the suppression mechanism is positioned to enclose the portion of the noise source when the access panel is returned to a closed position.

7. The enclosure unit of claim 3, wherein the noise suppression mechanism is configured to cover ˜30% or less of an entire outer surface area of the noise source.

8. The enclosure unit of claim 3, wherein the noise suppression mechanism further includes a noise treatment member positioned in a vicinity of the base end of the conformal barrier, an outer circumferential edge of the noise treatment member being in contact with the inner surface of the conformal barrier.

9. The enclosure unit of claim 8, wherein the noise treatment member is configured to cover an entire area of the inner surface of the access panel defined by the conformal barrier.

10. The enclosure unit of claim 8, wherein the noise treatment member is configured to cover only a portion of the inner surface of the access panel defined by the conformal barrier.

11. The enclosure unit of claim 8, wherein the noise treatment member includes a material draping from an area of the inner surface of the access panel defined by the conformal barrier.

12. A method of attaching a noise suppression mechanism to an enclosure unit that encloses a noise source, comprising:
attaching a conformal barrier to an inner surface of a panel of the enclosure unit such that the conformal barrier has a conforming fit with an outer surface of the noise source.

13. The method of claim 12, further comprising attaching an interface member to an inner surface of the wall of the conformal barrier.

14. The method of claim 12, further comprising attaching noise treatment member at a vicinity of the base end of the conformal barrier.
